(19) United States
(12) Patent Application Publication
(10) Pub. No.: US 2014/0094161 A1
(43) Pub. Date: Apr. 3, 2014

(54) WIRELESS TERMINAL DEVICE, RECORDING MEDIUM, AND CONTROL METHOD

(71) Applicant: Fujitsu Mobile Communications Limited, Kawasaki-shi (JP)

(72) Inventor: Naritoshi SAITO, Hino (JP)

(21) Appl. No.: 13/934,083

(22) Filed: Jul. 2, 2013

(30) Foreign Application Priority Data
Sep. 28, 2012 (JP) 2012-218081

(51) Int. Cl. H04W 88/06

(52) U.S. Cl. CPC H04W 88/06
USPC 455/419

(57) ABSTRACT

A CPU of a multi-mode wireless terminal capable of performing wireless communication using a plurality of communication systems including the LTE system determines whether an SMS with a command instructing to perform OTA setting is received from a network. When the SMS is received, the CPU performs the OTA data communication using communication by the LTE system by priority. When OTA data is received through the communication by the LTE system, the CPU stores the OTA data in a UICC. The CPU further executes a processing operation based on the OTA data stored in the UICC in response to a refresh instruction.

### CROSS-REFERENCE TO RELATED APPLICATION

This application is based upon and claims the benefit of priority of the prior Japanese Patent Application No. 2012-218081, filed on Sep. 28, 2012, the entire contents of which are incorporated herein by reference.

### FIELD

The embodiments discussed herein are related to a wireless terminal device, a recording medium, and a control method.

### BACKGROUND

In recent years, various communication systems, such as code division multiple access 2000 (CDMA2000), CDMA2000 1x, and CDMA2000 1x Evolution-Data Only (EV-DO), have been developed as third-generation (3G) mobile communication systems. The CDMA2000 1x is one of technical specifications included in the CDMA2000 standard, and will be hereinafter simply called “1x”. The CDMA2000 1x EV-DO is a standard that is improved from the 1x system and specializes in packet communication to have a higher communication speed, and will be hereinafter simply called “EVDO”.

Packet communication systems, such as long-term evolution (LTE) that uses communication of an orthogonal frequency division multiplexing access (OFDMA) system, have also been developed as standards for wireless communication of mobile phones.

For example, the 1x system and the EVDO system are services that have recently widely spread, and therefore have many base stations installed and communication areas covering wide ranges. Compared with the 1x system, the LTE system is a newer service, and therefore is spread centering on urban areas, having small communication areas included in the communication areas of the 1x system and the EVDO system.

Under such circumstances, for wireless terminals such as mobile phones, multi-mode wireless terminals have been devised that enable communication by a plurality of communication systems such as the 1x system, the EVDO system, and the LTE system. In the multi-mode wireless terminals, it is possible, according to a user operation, to select a communication mode in which, for example, the 1x system and the LTE system are used to simultaneously perform voice communication and packet communication, or a communication mode in which, for example, only the LTE system is used to perform packet communication.

The multi-mode wireless terminal uses the 1× system for the voice communication, and uses the EVDO system or the LTE system for the packet communication. The multi-mode wireless terminal can also receive a short message service (SMS) using the voice communication by the 1x system, or the packet communication by the EVDO system or the LTE system.

The multi-mode wireless terminal also receives over-the-air activation (OTA) data using the LTE system. In order for an OTA server on a network to write the OTA data, such as subscriber identification module (SIM) information, into a universal integrated circuit card (UICC) in the multi-mode wireless terminal, the OTA server sets the OTA in command information in an SMS. The OTA server then sends the SMS, in which the OTA is set, to the multi-mode wireless terminal in a point-to-point manner. When having received the SMS, the multi-mode wireless terminal acquires an LTE base station based on a normal period of search or the radio priority, and receives the OTA data via the acquired LTE base station. An example of related art is described in Japanese Laid-open Patent Publication No. 2004-172968.

When the multi-mode wireless terminal receives the SMS with a command for OTA setting while performing communication using a wireless communication system other than the LTE system, it takes time until the multi-mode wireless terminal starts receiving the OTA data through communication by the LTE system.

### SUMMARY

According to an aspect of an embodiment, a wireless terminal device capable of performing wireless communication using a plurality of communication systems includes a first communication system and a second communication system that enables communication at a higher communication speed than that of the first communication system. The wireless terminal device includes a memory and a processor coupled to the memory. The processor performs a process including: determining whether command information instructing to perform over-the-air activation (OTA) setting is received; and performing, when the command information is received, the OTA data communication using communication by the second communication system by priority.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a multi-mode wireless system of a first embodiment;

FIG. 2 is an explanatory diagram illustrating an example of a multi-mode wireless terminal of the first embodiment;

FIG. 3 is an explanatory diagram illustrating an example of a relation between a communication area of a 1x/EVDO system and communication areas of the LTE system in the multi-mode wireless system;

FIG. 4 is an explanatory diagram illustrating an example of a functional configuration in a CPU in the multi-mode wireless terminal of the first embodiment;

FIG. 5 is a table illustrating an example of a selection table;

FIG. 6 is an explanatory diagram illustrating an example of a priority table;

FIG. 7 is an explanatory diagram illustrating an example of a search period table;

FIG. 8 is a flowchart illustrating an example of a processing operation of the CPU with respect to an OTA flag setting process in the multi-mode wireless terminal;

FIG. 9 is a flowchart illustrating an example of a processing operation of the CPU with respect to an OTA data receiving process in the multi-mode wireless terminal;

FIG. 10 is an explanatory diagram illustrating an example of an operation sequence with respect to the OTA data receiving process related to an OTA server, an LTE base station, and the CPU and a UICC in the multi-mode wireless terminal of the first embodiment;

FIG. 11 is an explanatory diagram illustrating an example of a processing operation of the CPU with respect to an OTA data receiving process in the multi-mode wireless terminal of a second embodiment; and

FIG. 12 is an explanatory diagram illustrating a wireless terminal device that executes a control program.

### DESCRIPTION OF EMBODIMENTS

Preferred embodiments of the present invention will be explained with reference to accompanying drawings. Note that the disclosed technique is not limited by the embodiments. The embodiments to be illustrated below may be combined unless they contradict each other.

### [a] First Embodiment

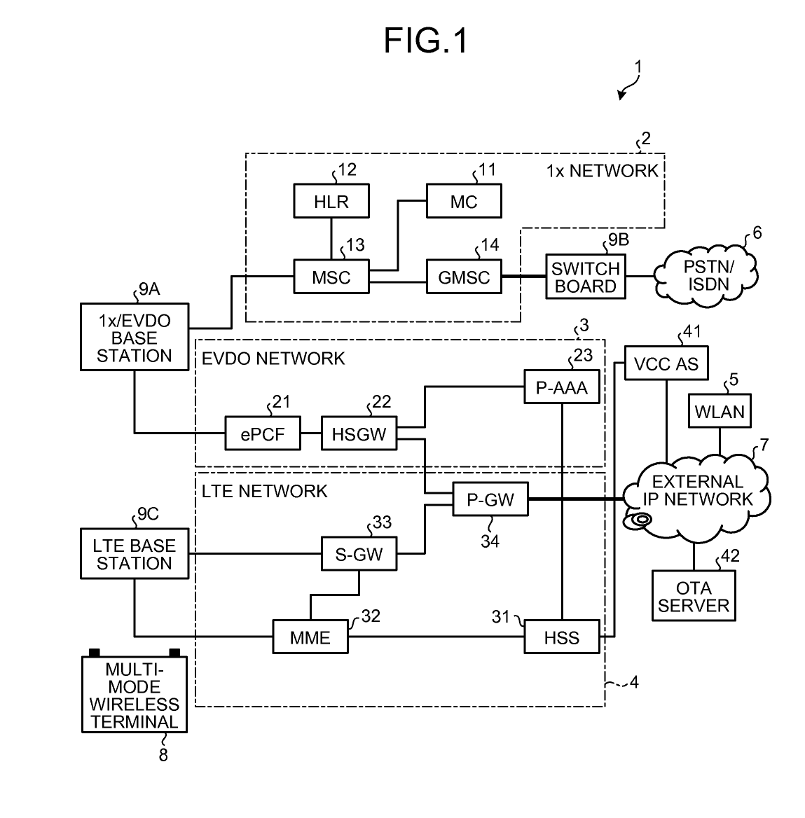

FIG. 1 is an explanatory diagram illustrating an example of a multi-mode wireless system of a first embodiment. This multi-mode wireless system 1 includes a 1x network 2, an EVDO network 3, an LTE network 4, and a wireless local area network (WLAN) 5. The multi-mode wireless system 1 also includes a public switched telephone network (PSTN)/integrated services digital network (ISDN) 6, an external Internet Protocol (IP) network 7, and a multi-mode wireless terminal 8.

The 1x network 2 includes a message center (MC) 11, a home location register (HLR) 12, a mobile switching center (MSC) 13, and a gateway mobile switching center (GMSC) 14. The MC 11, for example, delivers massages. The HLR 12 registers and manages subscriber information of service subscribers in the 1x network 2 and position information and authentication information of the service subscribers, in a manner corresponding to each other. The MSC 13 switches connection to each 1x/EVDO base station 9A. The GMSC 14 switches connection between a switch board 9B connected to the PSTN/ISDN 6 and the MSC 13.

The EVDO network 3 includes an evolved packet control function (ePCF) 21, a high rate packet data serving gateway (HSGW) 22, and a proxy-authentication, authorization and accounting (P-AAA) 23. The ePCF 21 is connected to the 1x/EVDO base station 9A, and performs a function of routing packets. The HSGW 22 performs conversion to high-speed packet data of the EVDO system. The P-AAA 23 manages authentication, authorization, and accounting for subscribers in the EVDO network 3.

The LTE network 4 includes a home subscriber server (HSS) 31, a mobility management entity (MME) 32, a serving-gateway (S-GW) 33, and a packet data network gateway (P-GW) 34. The HSS 31 manages subscriber information and the like in the LTE network 4. The MME 32 connects an LTE base station 9C with the S-GW 33, and performs network control, such as sequence control, a handover function, and position management of service subscribers in the LTE network 4, and a paging function to the LTE base station 9C at the time of receiving a call. The S-GW 33 is connected to the LTE base station 9C, and performs a function of routing packets. The P-GW 34 is a gateway that provides a communication connection among the HSGW 22 in the EVDO network, the external IP network 7, and the S-GW 33. The P-GW 34, for example, performs seamless packet communication between the EVDO network 3 and the LTE network 4. The HSS 31 and the P-AAA 23 are shared to be used by the EVDO network 3 and the LTE network 4.

The multi-mode wireless terminal 8 is a terminal of a service subscriber that can handle each mode of wireless communication in the multi-mode wireless system 1. A VCC AS (Voice Call Continuity Application Server) 41 is a server that provides, for example, a handover function of voice communication between a third-generation mobile phone and the external IP network 7. An OTA server 42 is a server that outputs, for example, OTA data from the external IP network 7. The OTA data is, for example, SIM information of, for example, an update program that updates a service program in the multi-mode wireless terminal 8.

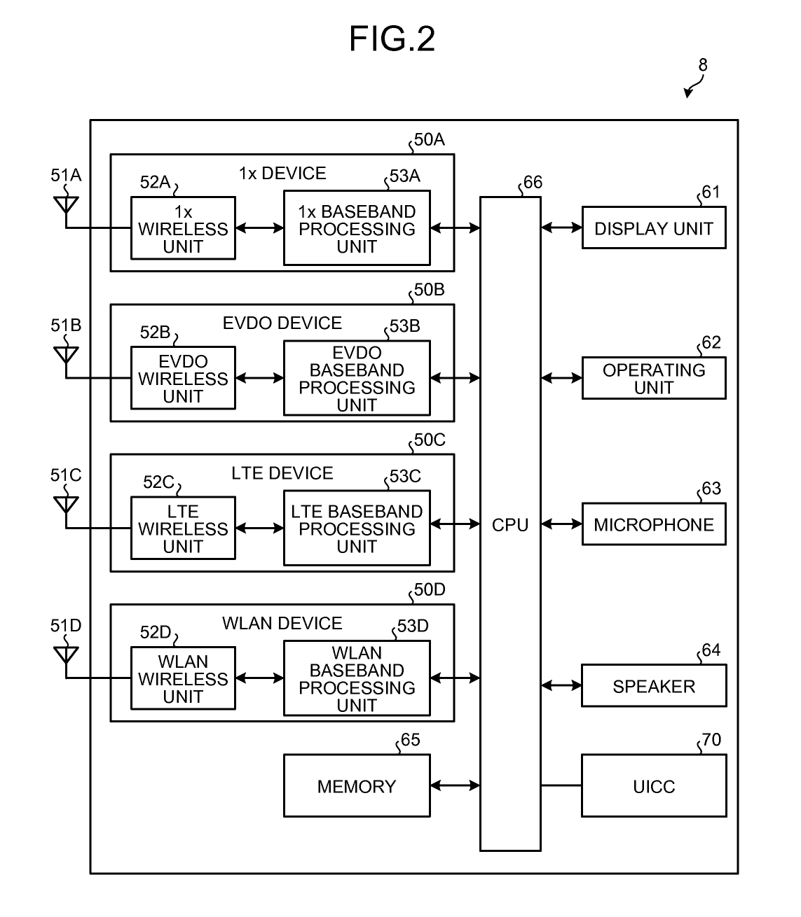

FIG. 2 is an explanatory diagram illustrating an example of the multi-mode wireless terminal 8 of the first embodiment. The multi-mode wireless terminal 8 illustrated in FIG. 2 includes a 1x device 50A, an EVDO device 50B, an LTE device 50C, and a WLAN device 50D. The multi-mode wireless terminal 8 also includes a display unit 61, an operating unit 62, a microphone 63, a speaker 64, a memory 65, and a central processing unit (CPU) 66. In addition, the multi-mode wireless terminal 8 incorporates a removable UICC 70. The UICC 70 stores therein, for example, the SIM information.

The 1x device 50A is an interface that performs wireless communication with the 1x network 2. The 1× device 50A includes an antenna 51A, a 1x wireless unit 52A, and a 1x baseband processing unit 53A. The 1x wireless unit 52A receives wireless signals of various data of voice and characters conforming to the 1x system via the antenna 51A, and transforms the received wireless signals into frequency domain signals. The 1x baseband processing unit 53A converts the frequency domain signals transformed from the wireless signals by the 1x wireless unit 52A into baseband signals, and demodulates the converted baseband signals. In addition, the 1x baseband processing unit 53A modulates transmission data into a baseband signal. The 1× wireless unit 52A transforms the baseband signal modulated by the 1x baseband processing unit 53A into a frequency domain signal, and outputs the transformed frequency domain transmission signal to be sent via the antenna 51A.

The EVDO device 50B is an interface that performs wireless communication with the EVDO network 3. The EVDO device 50B includes an antenna 51B, an EVDO wireless unit 52B, and an EVDO baseband processing unit 53B. The EVDO wireless unit 52B receives wireless signals of various data of voice and characters conforming to the EVDO system via the antenna 51B, and transforms the received wireless signals into frequency domain signals. The EVDO baseband processing unit 53B converts the frequency domain signals transformed from the wireless signals by the EVDO wireless unit 52B into baseband signals, and demodulates the converted baseband signals. In addition, the EVDO baseband processing unit 53B modulates transmission data into a baseband signal. The EVDO wireless unit 52B transforms the baseband signal modulated by the EVDO baseband processing unit 53B into a frequency domain signal, and outputs the transformed frequency domain transmission signal to be sent via the antenna 51B.

The LTE device 50C is an interface that performs wireless communication with the LTE network 4. The LTE device 50C includes an antenna 51C, an LTE wireless unit 52C, and an LTE baseband processing unit 53C. The LTE wireless unit 52C receives wireless signals of various data of voice and characters conforming to the LTE system via the antenna 51C, and transforms the received wireless signals into frequency domain signals. The LTE baseband processing unit 53C converts the frequency domain signals transformed from the wireless signals by the LTE wireless unit 52C into baseband signals, and demodulates the converted baseband signals. In addition, the LTE baseband processing unit 53C modulates transmission data into a baseband signal. The LTE wireless unit 52C transforms the baseband signal modulated by the LTE baseband processing unit 53C into a frequency domain signal, and outputs the transformed frequency domain transmission signal to be sent via the antenna 51C.

The WLAN device 50D is an interface that performs wireless communication with the WLAN 5. The WLAN device 50D includes an antenna 51D, a WLAN wireless unit 52D, and a WLAN baseband processing unit 53D. The WLAN wireless unit 52D receives wireless signals of various data of voice and characters conforming to the WLAN system via the antenna 51D, and transforms the received wireless signals into frequency domain signals. The WLAN baseband processing unit 53D converts the frequency domain signals transformed from the wireless signals by the WLAN wireless unit 52D into baseband signals, and demodulates the converted baseband signals. In addition, the WLAN baseband processing unit 53D modulates transmission data into a baseband signal. The WLAN wireless unit 52D transforms the baseband signal modulated by the WLAN baseband processing unit 53D into a frequency domain signal, and outputs the transformed frequency domain transmission signal to be sent via the antenna 51D.

The display unit 61 is an output interface that displays various types of information on a screen. The operating unit 62 is an input interface through which various types of information are entered. The microphone 63 is an input interface that picks up various types of sound. The speaker 64 is an output interface that acoustically outputs various types of sound. The memory 65 is an area that stores various types of information. The CPU 66 controls the entire multi-mode wireless terminal 8.

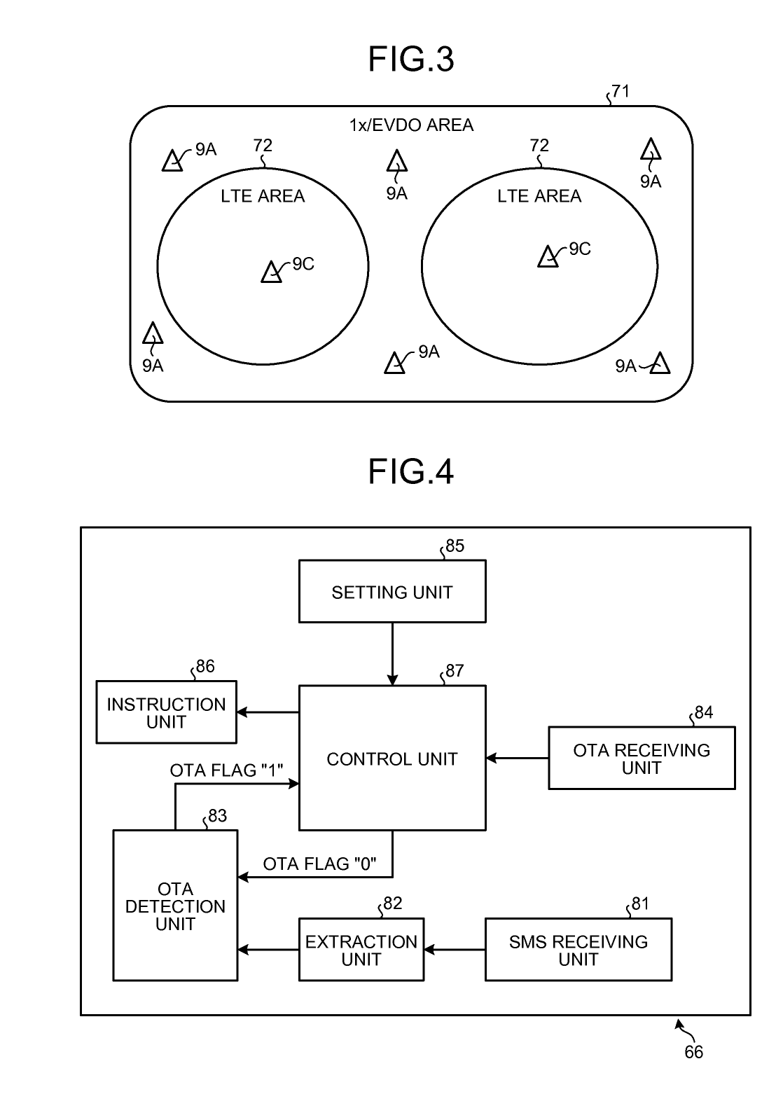

FIG. 3 is an explanatory diagram illustrating an example of a relation between a communication area of the 1x/EVDO system and communication areas of the LTE system in the multi-mode wireless system 1. The multi-mode wireless system 1 illustrated in FIG. 3 includes, for example, a communication area 71 of the 1x/EVDO system and communication areas 72 of the LTE system. The communication area 71 of the 1x/EVDO system, which has recently widely spread, covers a wide range. The communication area 71 of the 1x/EVDO system provides a voice communication service and a packet communication service. The communication area 72 of the LTE system, which is a newer service than the communication by the 1x/EVDO system, provides a packet communication service centering on densely populated urban areas. The communication area 72 of the LTE system provides a high-speed packet communication service. Consequently, the communication area 72 of the LTE system is smaller than the communication area 71 of the 1x/EVDO system. A plurality of aforementioned 1x/EVDO base stations 9A are placed in the communication area 71 of the 1x/EVDO system. A plurality of aforementioned LTE base stations 9C are placed in the communication area 72 of the LTE system.

FIG. 4 is an explanatory diagram illustrating an example of a functional configuration in the CPU 66 in the multi-mode wireless terminal 8 of the first embodiment. The CPU 66 illustrated in FIG. 4 includes an SMS receiving unit 81, an extraction unit 82, an OTA detection unit 83, an OTA receiving unit 84, a setting unit 85, an instruction unit 86, and a control unit 87. The CPU 66 reads a receiving program (not illustrated) stored in the memory 65, and executes a receiving process corresponding to the receiving program thus read so as to function as the SMS receiving unit 81. The SMS receiving unit 81 receives an SMS in a point-to-point manner from a network. The SMS receiving unit 81 receives the SMS, for example, through the 1x device 50A, the EVDO device 50B, or the LTE device 50C. The SMS receiving unit 81 normally receives the SMS (SMS over IMS) through the EVDO device 50B or the LTE device 50C via the EVDO network 3 or the LTE network 4, which is a packet communication network. When no packet communication network is available for communication, the SMS receiving unit 81 receives the SMS (SMS over 1x) through the 1x device 50A via the 1x network 2.

The CPU 66 reads an extraction program (not illustrated) stored in the memory 65, and executes an extraction process corresponding to the extraction program thus read so as to function as the extraction unit 82. The extraction unit 82 extracts a command in the SMS received by the SMS receiving unit 81. The CPU 66 reads a detection program (not illustrated) stored in the memory 65, and executes a detection process corresponding to the detection program thus read so as to function as the OTA detection unit 83. When having detected a command “7F” for OTA setting, the OTA detection unit 83 sets an OTA flag to “1”. The OTA detection unit 83 sets the OTA flag to “0” in response to a clear signal from the control unit 87.

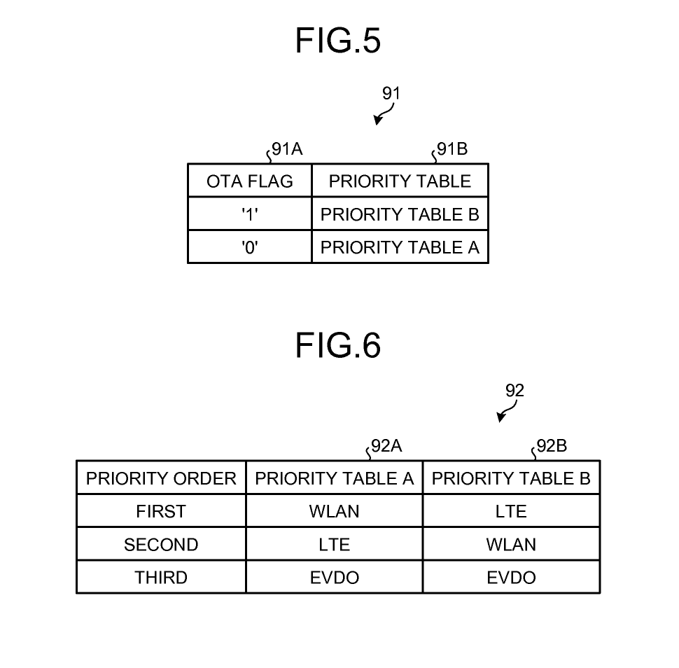

The CPU 66 reads a setting program (not illustrated) stored in the memory 65, and executes a setting process corresponding to the setting program thus read so as to function as the setting unit 85. The setting unit 85 selects, for example, a priority table that stores use priorities of the wireless communication types of the EVDO, the LTE, and the WLAN, and, based on the content of the selected priority table, sets a wireless communication type to be used. FIG. 5 is an explanatory diagram illustrating an example of a selection table. This selection table 91 illustrated in FIG. 5 manages priority tables 91B for respective values of an OTA flag 91A. The selection table 91 is stored in the memory 65. When, with reference to the selection table 91, the OTA flag 91A is “1”, the setting unit 85 selects a priority table 91B of “B”. The setting unit 85 selects a priority table 91B of “A” when the OTA flag 91A is “0”. FIG. 6 is an explanatory diagram illustrating an example of a priority table. This priority table 92 illustrated in FIG. 6 manages a priority table 92A of “A” and a priority table 92B of “B” in a manner corresponding to each other. The priority table 92 is stored in the memory 65. The priority table 92A of “A” illustrated in FIG. 6 gives, as the use priorities, the first priority to the WLAN, the second priority to the LTE, and the third priority to the EVDO. The priority table 92B of “B” gives, as the use priorities, the first priority to the LTE, the second priority to the WLAN, and the third priority to the EVDO.

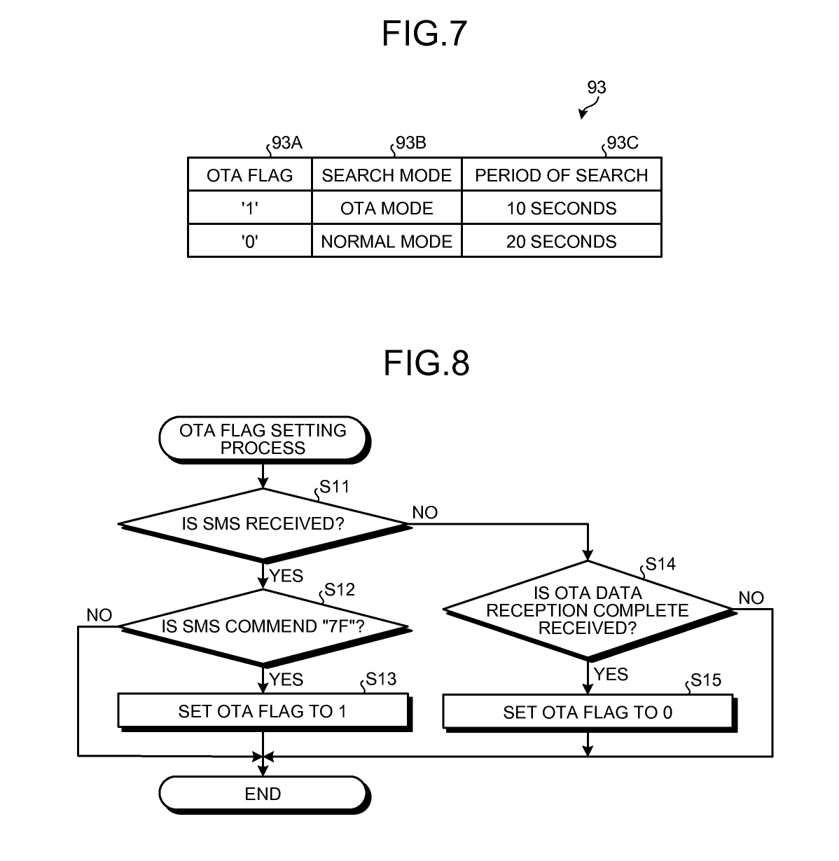

The CPU 66 reads an instruction program (not illustrated) stored in the memory 65, and executes an instruction process corresponding to the instruction program thus read so as to function as the instruction unit 86. Corresponding to the OTA flag, the instruction unit 86 gives an instruction of a period of search for the LTE base station 9C to the LTE device 50C. FIG. 7 is an explanatory diagram illustrating an example of a search period table. This search period table 93 illustrated in FIG. 7 manages an OTA flag 93A, a search mode 93B, and a period of search 93C in a manner corresponding to each other. The search period table 93 is stored in the memory 65. When, with reference to the search period table 93, the OTA flag 93A is “1”, the instruction unit 86 gives an instruction of a period of search of an OTA mode, that is, 10 seconds, to the LTE device 50C. As a result, the instruction unit 86 gives an instruction of a search operation of searching for the LTE base station 9C at the period of 10 seconds using the LTE device 50C. When, with reference to the search period table 93, the OTA flag 93A is “0”, the instruction unit 86 gives an instruction of a period of search of a normal mode, that is, 20 seconds, to the LTE device 50C. As a result, the instruction unit 86 gives an instruction of a search operation for the LTE base station 9C at the period of 20 seconds using the LTE device 50C.

The CPU 66 reads a data receiving program (not illustrated) stored in the memory 65, and executes a data receiving process corresponding to the data receiving program thus read so as to function as the OTA receiving unit 84. The OTA receiving unit 84 sets a logical channel for OTA to the OTA server 42 via the acquired LTE base station 9C, and receives OTA data from the OTA server 42.

The CPU 66 reads a control program (not illustrated) stored in the memory 65, and executes a control process corresponding to the control program thus read so as to function as the control unit 87. The control unit 87 controls the entire CPU 66. When having received the OTA data through the OTA receiving unit 84 via the LTE base station 9C, the control unit 87 stores the OTA data in the UICC 70. Then, when having detected a refresh instruction from the UICC 70, the control unit 87 reloads the OTA data stored in the UICC 70, and executes a processing operation based on the reloaded OTA data. When having completed receiving the OTA data through the OTA receiving unit 84, the control unit 87 outputs a clear signal to the OTA detection unit 83 in response to the completion of the receiving. As a result, the OTA detection unit 83 sets the OTA flag currently set as “1” to “0” in response to the clear signal.

Next, a description will be made of the operation of the multi-mode wireless terminal 8 of the first embodiment. FIG. 8 is a flowchart illustrating an example of the processing operation of the CPU 66 with respect to the OTA flag setting process in the multi-mode wireless terminal 8. The OTA flag setting process illustrated in FIG. 8 is a process of setting the OTA flag based on the content of the command in the received SMS.

As illustrated in FIG. 8, the SMS receiving unit 81 in the CPU 66 determines whether an SMS is received (Step S11). If an SMS is received (Yes at Step S11), the extraction unit 82 in the CPU 66 determines whether the command in the SMS is “7F” (Step S12). Note that the command “7F” is a command instructing to perform the OTA setting. If the command in the SMS is “7F” (Yes at Step S12), the OTA detection unit 83 determines that the command is a command for the OTA setting, and sets the OTA flag to “1” (Step S13). Then, the OTA detection unit 83 terminates the processing operation illustrated in FIG. 8.

If the command in the SMS is not “7F” (No at Step S12), the extraction unit 82 terminates the processing operation illustrated in FIG. 8. If no SMS is received (No at Step S11), the OTA receiving unit 84 determines whether a reception complete of OTA data is received (Step S14). If a reception complete of OTA data is received (Yes at Step S14), the control unit 87 outputs a clear signal to the OTA detection unit 83 to set the OTA flag to “0” (Step S15), and terminates the processing operation illustrated in FIG. 8.

If no reception complete of OTA data is received (No at Step S14), the OTA receiving unit 84 terminates the processing operation illustrated in FIG. 8.

When an SMS including the command “7F” is received, the CPU 66 in the OTA flag setting process illustrated in FIG. 8 determines the SMS to be an SMS instructing to perform the OTA setting, and sets the OTA flag to “1”. As a result, the CPU 66 can set the OTA flag to “1” based on the instruction by the SMS from the external network.

When a reception complete of OTA data is received, the CPU 66 sets the OTA flag to “0”. As a result, the CPU 66 can set the OTA flag to “0” based on the instruction by the SMS from the external network.

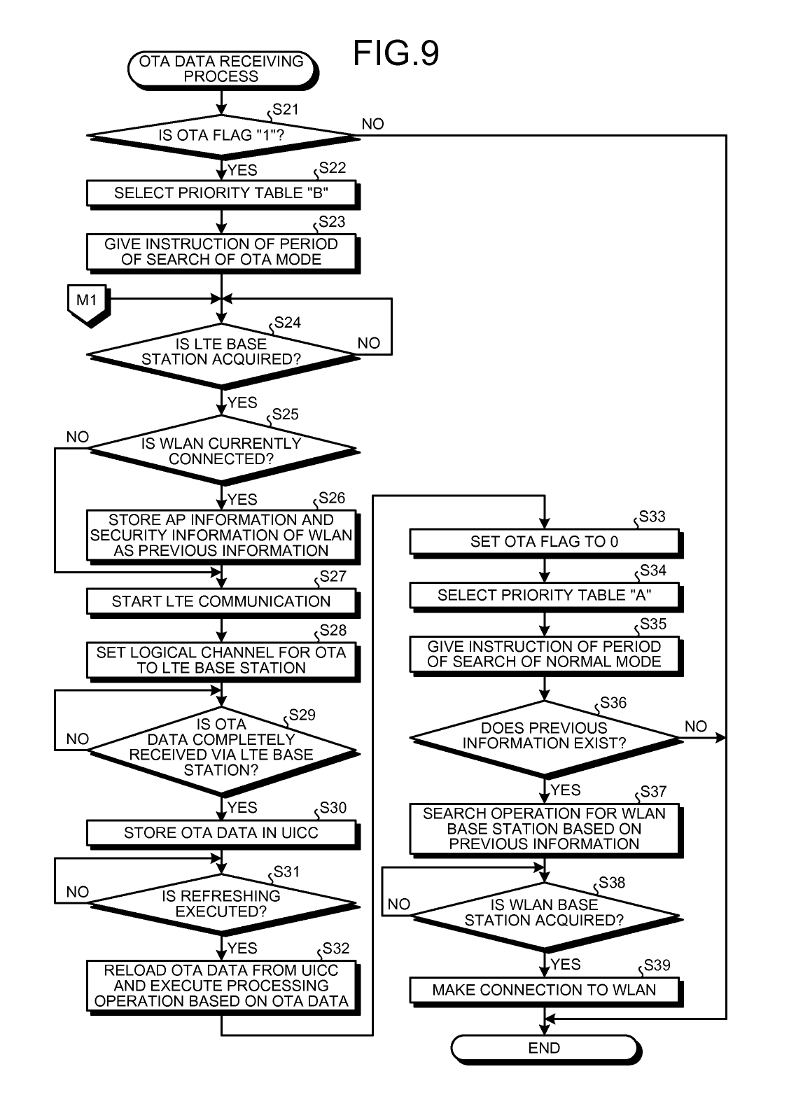

FIG. 9 is a flowchart illustrating an example of the processing operation of the CPU 66 with respect to the OTA data receiving process in the multi-mode wireless terminal 8. The OTA data receiving process illustrated in FIG. 9 is a process of receiving the OTA data using the LTE system by priority when the OTA flag is “1”. In FIG. 9, the control unit 87 in the CPU 66 determines whether the OTA flag is “1” (Step S21). If the OTA flag is “1” (Yes at Step S21), the setting unit 85 in the CPU 66 selects the priority table 92B of “B” in FIG. 6 with reference to the selection table 91 of FIG. 5 (Step S22). The setting unit 85 selects the priority table 92B of “B” and sets the use priority to LTE, which is the first priority. With reference to the search period table 93, the instruction unit 86 in the CPU 66 gives an instruction of the period of search corresponding to the OTA mode according to the current OTA flag to the LTE device 50C (Step S23). The instruction unit 86 gives an instruction of the period of search of 10 seconds to the LTE device 50C. As a result, it is possible to reduce time required for acquiring the LTE base station 9C.

The control unit 87 in the CPU 66 determines whether the LTE base station 9C is acquired based on the period of search using the LTE device 50C (Step S24). Note that the control unit 87 has a higher probability of acquiring the LTE base station 9C than that in the normal mode. If the LTE base station 9C is acquired (Yes at Step S24), the control unit 87 determines whether the WLAN 5 is currently connected (Step S25). If the WLAN 5 is currently connected, the control unit 87 uses the WLAN device 50D to store access point (AP) information and security information of the WLAN 5 as previous information in the memory 65 (Step S26).

The control unit 87 starts communication by the LTE system using the LTE device 50C (Step S27), and sets the logical channel for OTA to the LTE base station 9C (Step S28). After setting the logical channel for OTA, the control unit 87 determines whether the OTA data is completely received via the LTE base station 9C (Step S29).

If the OTA data is completely received via the LTE base station 9C (Yes at Step S29), the control unit 87 stores the OTA data in the UICC 70 (Step S30). After storing the OTA data in the UICC 70, the control unit 87 determines whether the refresh operation is executed in response to the refresh instruction from the UICC 70 (Step S31). If the refresh operation is executed (Yes at Step S31), the control unit 87 reloads the OTA data from the UICC 70, and executes the processing operation based on the OTA data (Step S32). After executing the processing operation based on the OTA data, the control unit 87 outputs a clear signal to the OTA detection unit 83 to set the OTA flag to “0” (Step S33). While the control unit 87 sets the OTA flag to “0” by outputting the clear signal to the OTA detection unit 83 after executing the processing operation based on the OTA data, the control unit 87 may set the OTA flag to “0” at the time when the OTA data is completely received via the LTE base station 9C.

After the OTA flag is set to “0”, the setting unit 85 selects the priority table of “A” corresponding to the OTA flag value of “0” with reference to the selection table 91 (Step S34). As a result, the setting unit 85 selects the priority table of “A” and sets the use priority to WLAN, which is the first priority. Furthermore, the instruction unit 86 gives an instruction of the period of search of the normal mode corresponding to the OTA flag value of “0” to the LTE device 50C (Step S35). The period of search of the normal mode is set to, for example, 20 seconds, and thus gives a lower probability of acquiring the LTE base station 9C than the probability given by the period of search (10 seconds) of the OTA mode.

The control unit 87 determines whether the previous information exists in the memory 65 (Step S36). If the previous information exists (Yes at Step S36), the instruction unit 86 gives an instruction of a search operation for a WLAN base station based on the previous information using the WLAN device 50D (Step S37). The control unit 87 determines whether a WLAN base station is acquired (Step S38).

If a WLAN base station is acquired (Yes at Step S38), the control unit 87 uses the WLAN device 50D to make connection to the WLAN 5 (Step S39), and terminates the processing operation illustrated in FIG. 9.

If the OTA flag is not “1” (No at Step S21), the control unit 87 determines that the OTA flag is “0”, and terminates the processing operation illustrated in FIG. 9. If the LTE base station 9C is not acquired (No at Step S24), the instruction unit 86 gives an instruction of a search operation at intervals of the set period, and then performs Step S24 so as to determine whether the LTE base station 9C is acquired.

If the WLAN 5 is currently not connected (No at Step S25), the control unit 87 performs Step S27 so as to start communication by the LTE system. If the OTA data is not received via the LTE base station 9C (No at Step S29), the control unit 87 performs Step S29 so as to determine whether the OTA data is received. If the refresh operation is not executed (No at Step S31), the control unit 87 performs Step S31 so as to determine whether the refresh operation is executed.

If the previous information does not exist (No at Step S36), the control unit 87 terminates the processing operation illustrated in FIG. 9. If no WLAN base station is acquired (No at Step S38), the control unit 87 performs Step S38 so as to determine whether a WLAN base station is acquired.

In the OTA data receiving process illustrated in FIG. 9, if the OTA flag is “1”, the CPU 66 sets the use priority of the LTE system higher than that of the normal mode, and sets the period of search for acquiring the LTE base station 9C shorter than that of the normal mode. As a result, the CPU 66 can quickly acquire the LTE base station 9C so as to be able to reduce time until the OTA data is received through the communication by the LTE system.

Moreover, the CPU 66 stores the OTA data in the UICC 70 when the OTA data is received through the LTE communication. As a result, the CPU 66 can store the OTA data in the UICC 70 quickly.

The CPU 66 sets the OTA flag to “0” when the OTA data stored in the UICC 70 is reloaded and the processing operation is executed based on the OTA data. As a result, the CPU 66 can automatically set the OTA flag to “0”.

When having set the OTA flag to “0”, the CPU 66 returns the use priority of the LTE system to that of the normal mode, and returns the period of search for acquiring the LTE base station 9C to that of the normal mode. As a result, the CPU 66 can resume the communication state immediately before receiving the OTA data.

If the WLAN 5 is in a connected state immediately before the OTA data is received, the CPU 66 stores the AP information and the security information of the WLAN 5 as the previous information. Then, when having set the OTA flag to “0”, the CPU 66 makes connection to the WLAN 5 based on the previous information. As a result, after executing the processing operation based on the OTA data, the CPU 66 can automatically resume the connection to the WLAN 5, which was in a connected state immediately before the OTA data was received.

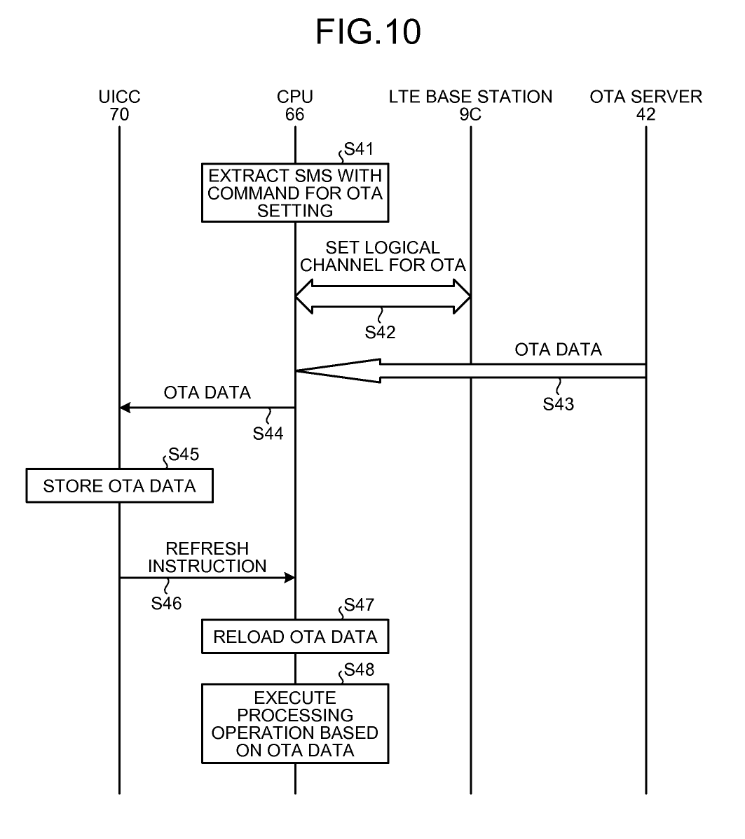

FIG. 10 is an explanatory diagram illustrating an example of an operation sequence with respect to the OTA data receiving process related to the OTA server 42, the LTE base station 9C, and the CPU 66 and the UICC 70 in the multi-mode wireless terminal 8 of the first embodiment. The CPU 66 of the multi-mode wireless terminal 8 extracts the command for OTA setting in the SMS (Step S41). Using the LTE device 50C, the CPU 66 sets the logical channel to the LTE base station 9C using a radio access bearer (RAB) for OTA (Step S42). After setting the logical channel to the LTE base station 9C, the CPU 66 receives the OTA data from the OTA server 42 through the logical channel (Step S43). When having received the OTA data via the LTE base station 9C, the CPU 66 transmits the OTA data to the UICC 70 (Step S44). The UICC 70 stores therein the received OTA data (Step S45).

When having detected the refresh instruction from the UICC 70 (Step S46), the CPU 66 reloads the OTA data from the UICC 70 (Step S47). Then, the CPU 66 executes the processing operation based on the reloaded OTA data (Step S48), and terminates the processing operation illustrated in FIG. 10.

When the OTA flag is “1”, the CPU 66 of the first embodiment sets the period of search for acquiring the LTE base station 9C shorter than that of the normal mode. As a result, the CPU 66 can quickly acquire the LTE base station 9C so as to be able to reduce time until starting receiving the OTA data through the communication by the LTE system.

When the OTA flag is “1”, the CPU 66 sets the use priority of the LTE system higher than that of the normal mode, and thus can reduce the time until starting receiving the OTA data through the communication by the LTE system.

Moreover, the CPU 66 stores the OTA data in the UICC 70 when the OTA data is received through the LTE communication. As a result, the CPU 66 can store the OTA data in the UICC 70 quickly.

When having set the OTA flag to “0”, the CPU 66 returns the use priority of the LTE system to that of the normal mode. As a result, the CPU 66 can automatically return the use priority to that immediately before the start of receiving of the OTA data.

When having set the OTA flag to “0”, the CPU 66 returns the period of search for acquiring the LTE base station 9C to that of the normal mode. As a result, the CPU 66 can automatically return the period of search to that immediately before the start of receiving of the OTA data.

When having set the OTA flag to “1”, the CPU 66 stores the setting information (previous information) of the communication system currently in use into the memory 65, and, when the OTA data is completely received, resumes the communication system immediately before the start of receiving of the OTA data based on the previous information. As a result, the CPU 66 can automatically resume the communication system immediately before the start of receiving of the OTA data.

For example, if the WLAN 5 is in a connected state immediately before the OTA data is received, the CPU 66 stores in the memory 65 the AP information and the security information of the WLAN 5 as the previous information. Then, when having set the OTA flag to “0”, the CPU 66 makes connection to the WLAN 5 based on the previous information. As a result, after executing the processing operation based on the OTA data, the CPU 66 can resume the connection to the WLAN 5, which was in a connected state immediately before the OTA data was received.

In the first embodiment described above, when the OTA flag is “1”, the period of search for the LTE base station 9C is set to 10 seconds, and, using the priority table of “B”, the LTE communication is automatically started so as to receive the OTA data. However, the start of the LTE communication may be left to a user operation. An embodiment in this case will be described as a second embodiment. Note that the same signs will be given to the same configurations as those of the first embodiment described above, and thus, description of the duplicate configurations and operations thereof will be omitted.

### [b] Second Embodiment

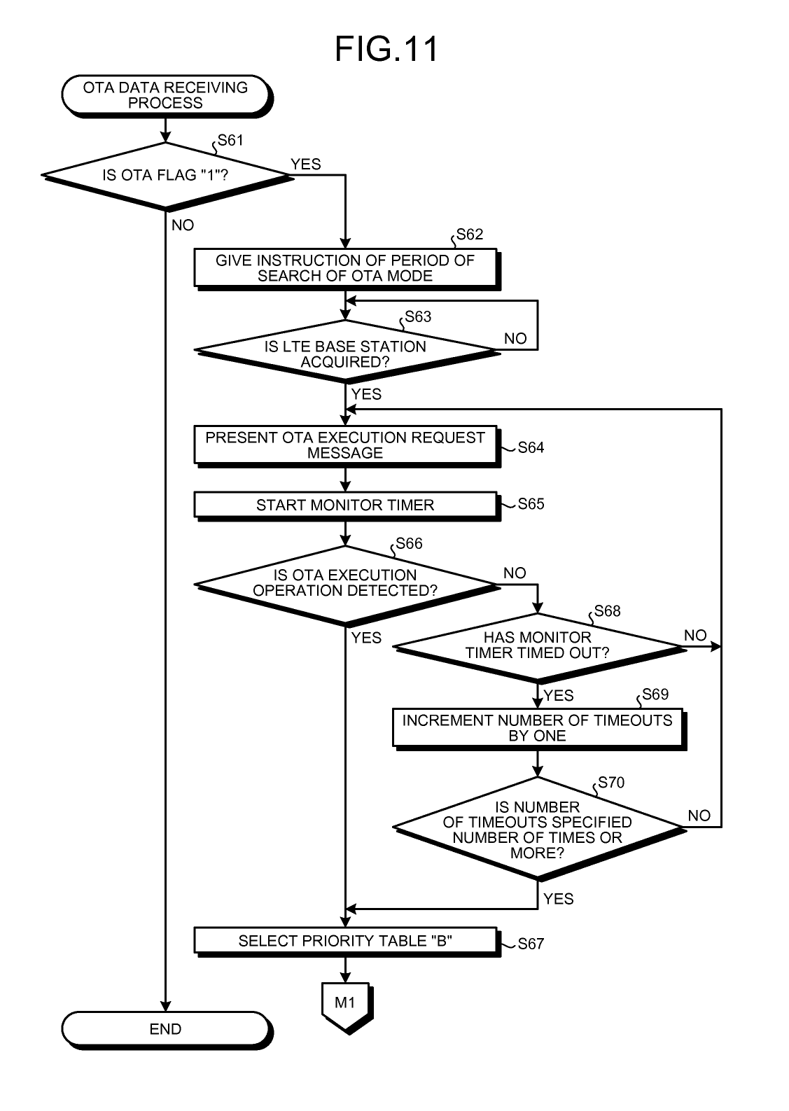

FIG. 11 is a flowchart illustrating an example of a processing operation of the CPU 66 with respect to an OTA data receiving process in the multi-mode wireless terminal 8 of a second embodiment. In FIG. 11, the control unit 87 in the CPU 66 determines whether the OTA flag is “1” (Step S61). If the OTA flag is “1” (Yes at Step S61), the instruction unit 86 gives an instruction of the period of search of 10 seconds, which corresponds to the OTA mode, to the LTE device 50C (Step S62).

After setting the period of search to that of the OTA mode, the control unit 87 determines, using the LTE device 50C, whether the LTE base station 9C is acquired (Step S63). If the LTE base station 9C is acquired (Yes at Step S63), the control unit 87 presents an OTA execution request message on the display unit 61 (Step S64). The OTA execution request message refers to a message to a user to prompt the user to perform an operation to start receiving of the OTA data.

After presenting the OTA execution request message to request the start of receiving of the OTA data, the control unit 87 starts a monitor timer (Step S65), and determines whether an OTA execution operation is detected (Step S66). Although the monitor timer is set to, for example, 30 minutes for convenience of explanation, the set time is not limited to that particular value. The reason for leaving the start of receiving of the OTA data to the user is that the start of receiving of the OTA data involves an interruption of a communication system currently in connection, if exists.

If the OTA execution operation is detected (Yes at Step S66), the setting unit 85 selects the priority table of “B” (Step S67), and then performs M1 illustrated in FIG. 9.

If the OTA execution operation is not detected (No at Step S66), the control unit 87 determines whether the monitor timer started at Step S65 has timed out (Step S68). If the monitor timer has timed out (Yes at Step S68), the control unit 87 increments the number of timeouts by one (Step S69), and determines whether the number of timeouts is a specified number of times or more (Step S70). Note that the specified number of times is not limited to, for example, a particular value given for convenience of explanation. If the number of timeouts is the specified number of times or more (Yes at Step S70), the control unit 87 performs Step S67 so as to select the priority table of “B”. For example, if the OTA execution operation is not detected for a specified number of times of four with 30 minutes per time, that is, for two hours, the control unit 87 automatically selects the priority table of “B”. As a result, the priority table of “B” is automatically selected, so that the use priority of the LTE system becomes the first priority.

If the monitor timer has not timed out (No at Step S68), the control unit 87 performs Step S64 so as to present the OTA execution request message. If the number of timeouts is not the specified number of times or more (No at Step S70), the control unit 87 also performs Step S64 so as to present the OTA execution request message.

If the OTA flag is not “1” (No at Step S61), the control unit 87 terminates the processing operation illustrated in FIG. 11. If the LTE base station 9C is not acquired (No at Step S63), the control unit 87 performs Step S63 so as to determine whether the LTE base station 9C is acquired.

When the LTE base station 9C is acquired at the shorter period of search for the LTE base station 9C, the CPU 66 in the OTA data receiving process illustrated in FIG. 11 presents the message prompting the operation of starting the receiving of the OTA data on the display unit 61. As a result, the user can view the message, and can interrupt the communication system currently in connection and give an instruction of starting the receiving of the OTA data using the LTE base station 9C, according to the user operation.

The CPU 66 presents the message prompting the starting of receiving of the OTA data until the number of timeouts of the monitor timer reaches the specified number of times or more, and, when the number of timeouts reaches the specified number of times or more, automatically starts the receiving operation of the OTA data through the LTE base station 9C. As a result, the user can start the receiving operation of the OTA data without a need for operation.

When the LTE base station 9C is acquired at the shorter period of search for the LTE base station 9C, the CPU 66 of the second embodiment presents the message prompting the operation of starting the receiving of the OTA data on the display unit 61. As a result, the user can view the message, and can interrupt the communication system currently in connection and give an instruction of starting the receiving of the OTA data through the LTE base station 9C, according to the user operation.

In the above-described embodiments, the time until the OTA data is received using the LTE system is reduced by raising the use priority of the LTE system and by shortening the period of search for the LTE base station 9C. However, the time until the OTA data is received using the LTE system may be reduced by employing either one of the methods of raising the use priority of the LTE system and of shortening the period of search for the LTE base station 9C.

While, in the above-described embodiments, the OTA flag is set to “1” when an SMS with a command for OTA setting is received, the OTA flag may be set to “1” when a request for a service using the LTE system is received, regardless of the OTA setting command. The service using the LTE system includes, for example, a download service of high-security and large-capacity data from a business operator, a fighting game with low latency, and a streaming service of video data with high QoS and low latency.

While, in the above-described embodiments, the LTE system is used by priority when the OTA flag is set to “1”, the LTE system may be used when an SMS with a command for OTA setting is received, or when a request for an LTE service is received, without a need for setting the OTA flag.

While, in the above-described embodiments, the OTA server 42 is connected to the external IP network 7, the OTA server 42 may be connected to, for example, the EVDO network 3 or the LTE network 4.

While the above-described embodiments exemplify the multi-mode wireless terminal 8 having the communication function using the LTE system, the same advantageous effect is obtained by applying a WiMAX system instead of the LTE system.

While the above-described embodiments exemplify a smartphone as the multi-mode wireless terminal 8, the same advantageous effect is obtained by applying the present invention to a tablet computer or an information terminal having a multi-mode wireless function.

The constituent elements illustrated in the drawings need not be physically configured as illustrated. In other words, the specific modes of distribution and integration of the elements are not limited to those illustrated in the drawings, and all or some of the elements can be functionally or physically distributed or integrated in any units according to various types of load, states of use, and the like.

In addition, all or any part of the processing functions executed in each unit may be executed on the central processing unit (CPU) (or a microcomputer such as a micro processing unit [MPU] or a micro controller unit [MCU]). Furthermore, all or any part of the processing functions may obviously be executed on a program that performs analysis on the CPU (or the microcomputer such as the MPU or the MCU), or on hardware by wired logic.

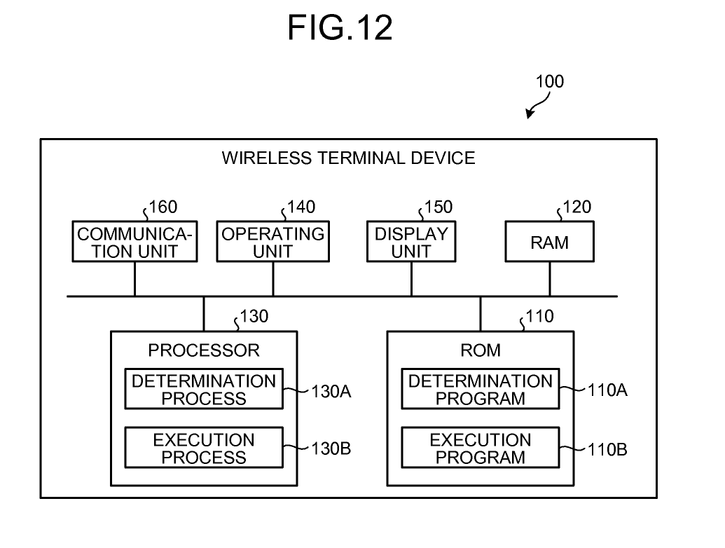

The processes described in the embodiments can be implemented by executing a prepared program on the wireless terminal device. A description will be made below of an example of a wireless terminal device that executes a program having the same functions as those described in the embodiments above. FIG. 12 is an explanatory diagram illustrating this wireless terminal device 100 that executes a control program.

In FIG. 12, the wireless terminal device 100, which executes the control program, includes a ROM 110, a RAM 120, a processor 130, an operating unit 140, a display unit 150, and a communication unit 160. The ROM 110 stores therein the control program in advance that performs the same functions as those described in the embodiments above. The control program may be recorded in a recording medium readable by a drive (not illustrated), instead of in the ROM 110. The recording medium may be, for example, a portable recording medium such as a CD-ROM, a DVD, a USB memory, or an SD card, or a semiconductor memory such as a flash memory. The control program includes a determination program 110A and an execution program 110B as illustrated in FIG. 12. The determination program 110A and the execution program 110B may be integrated or distributed as appropriate.

The processor 130 reads the programs 110A and 110B from the ROM 110, and executes the programs thus read. Then, the processor 130 makes the programs 110A and 110B respectively function as a determination process 130A and an execution process 130B. The communication unit 160 has a multi-mode wireless communication function supporting a plurality of communication systems including the LTE system.

The processor 130 of the wireless terminal device 100 determines whether command information instructing to perform the OTA setting is received. If the command information is received, the processor 130 performs the OTA data communication using communication by the LTE system by priority. As a result, the wireless terminal device 100 can reduce the time until starting receiving the OTA data through the communication by the LTE system.

According to an aspect disclosed herein, it is possible to reduce time until starting receiving OTA data through communication by the LTE system.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless terminal device capable of performing wireless communication using a plurality of communication systems including a first communication system and a second communication system that enables communication at a higher communication speed than that of the first communication system, the wireless terminal device comprising:
a memory; and
a processor coupled to the memory, wherein the processor performs a process comprising:
determining whether command information instructing to perform over-the-air activation (OTA) setting is received; and
performing, when the command information is received, the OTA data communication using communication by the second communication system by priority.

2. The wireless terminal device according to claim 1, wherein the performing includes referring, when the command information is received, to the memory storing therein priorities of the communication systems, setting the priority of the second communication system higher than a normal priority, and based on the priority set higher, performing the OTA data communication using the communication by the second communication system.

3. The wireless terminal device according to claim 1, wherein the performing includes setting, when the command information is received, an acquiring period for a base station of the second communication system among the communication systems shorter than a normal period, acquiring the base station of the second communication system based on the acquiring period set shorter, and performing the OTA data communication using the communication by the second communication system via the acquired base station of the second communication system.

4. The wireless terminal device according to claim 2, wherein the processor further performs a process of resetting, when the OTA data communication is completed, the priority of the second communication system stored in the memory to the normal priority.

5. The wireless terminal device according to claim 4, wherein the processor further performs a process of resetting, when the OTA data communication is completed, the acquiring period set for the base station of the second communication system to the normal period.

6. The wireless terminal device according to claim 1, wherein the processor further performs a process comprising:
storing, when the command information is received, setting information of a communication system currently in use among the communication systems in the memory; and
resuming, when the OTA data communication is completed, the communication by the communication system based on the setting information of the communication system in the memory.

7. The wireless terminal device according to claim 1, wherein the performing comprises: determining, when the command information is received, whether an instruction operation instructing to perform the OTA data communication is detected; and
performing, when the instruction operation is detected, the OTA data communication using the communication by the second communication system.

8. The wireless terminal device according to claim 1, wherein the determining includes determining whether a short message including the command information is received from a network.

9. A computer-readable recording medium having stored therein a control program of a wireless terminal device capable of performing wireless communication using a plurality of communication systems including a first communication system and a second communication system that enables communication at a higher communication speed than that of the first communication system, the program causing the wireless terminal device to execute a process comprising:
determining whether command information instructing to perform over-the-air activation (OTA) setting is received; and
performing, when the command information is received, the OTA data communication using communication by the second communication system by priority.

10. A control method of a wireless terminal device capable of performing wireless communication using a plurality of communication systems including a first communication system and a second communication system that enables communication at a higher communication speed than that of the first communication system, the control method comprising, by the wireless terminal device:
determining whether command information instructing to perform over-the-air activation (OTA) setting is received; and
performing, when the command information is received, the OTA data communication using communication by the second communication system by priority.
